(19) United States
(12) Patent Application Publication
(10) Pub. No.: US 2007/0080889 A1
(43) Pub. Date: Apr. 12, 2007

(54) Electrically small multi-level loop antenna on flex for low power wireless hearing aid system

(75) Inventor: Wen Hui Zhang, Burlington (CA)

Correspondence Address: David B. Cochran, Esq.;Jones Day, North Point, 901 Lakeside Avenue, Cleveland, OH, 44114, US

(73) Assignee: Gennum Corporation

(21) Appl. No.: 11/247,530

(22) Filed: Oct. 11, 2005

(51) Int. Cl. H01Q 1/36

(52) U.S. Cl. 343/895; 343/718; 343/702

(57) ABSTRACT

A hearing device having a multiple-level loop antenna is provided. The hearing device includes a housing structure and a communication system for receiving wireless signals. The antenna is configured to make more than one revolution around a center point and to be on multiple levels. A first part of the antenna is on a first level and one or more parts of the antenna are on one or more levels above the first part. The loop antenna may be affixed to a flexible dielectric substrate, along with at least a portion of a matching network for coupling the loop antenna to the communication system.

### FIELD

The technology described in this patent document relates generally to the field of antennas. More particularly, the patent document describes a loop antenna on flex material that is particularly well-suited for use in an ultra-low power wireless hearing aid system, but which may also have general applications in the field of wireless communication devices.

### BACKGROUND

Antennas at radio or microwave frequency are typically not robust when dealing with certain application issues, such as human proximity, or against the small size requirement that is necessary for hearing aids, such as BTE (behind the ear), ITC (in the canal), and CIC (completely in the canal) shell sizes. Loop antennas in various communication systems are conventionally built on rigid substrates and the matching circuits are typically fixed on the substrates as well. Certain wireless broadcasting frequencies, such as 900 MHz, cannot be received with conventional antennas that are small enough to be contained in an ITC or CIC type shell. Conventional antennas that are able to receive at 900 Mhz are also typically too large to be placed in conventional-sized boots that attach to hearing aids.

### BRIEF DESCRIPTION OF THE DRAWINGS

FIG. 1 is a layout of an example loop antenna.

FIG. 2 illustrates an example loop antenna on flex attached to a behind the ear hearing aid device.

FIG. 3 is an example matching topology for a miniature wireless device.

FIG. 4 is an example matching topology for a miniature wireless device where a portion of the matching network is located within the shell of the device.

FIG. 5 is a schematic diagram of an example narrow bandwidth matching circuit.

FIG. 6 is a schematic diagram of an example medium bandwidth matching circuit.

FIG. 7 is a perspective view of an example loop antenna on flex attached to a behind the ear hearing aid device.

FIG. 8 is a side view of an example loop antenna on flex attached to a behind the ear hearing aid device.

FIG. 9 is a line drawing of another example loop antenna.

FIG. 10 is a layout of the example loop antenna of FIG. 9.

FIG. 11 is a perspective view of an example two revolution, three level, loop antenna on flex with zig-zag transitions.

FIG. 12 is a perspective view of an example two revolution, two level, loop antenna on flex with spiral transition.

FIG. 13 is a perspective view of an example three revolution, three level, loop antenna on flex with zig-zag transitions.

FIG. 14 is a perspective view of an example three revolution, three level, loop antenna on flex.

FIG. 15 is an example matching circuit topology.

FIG. 16 is a more detailed example matching circuit topology.

FIG. 17 is a see-through, perspective view of an example boot housing for an example multi-level loop antenna on flex.

FIG. 18 is a side view of a BTE hearing aid situated on a human ear.

FIG. 19 is partial cross-section view of an ITE hearing aid situated in a human ear.

FIG. 20 is partial cross-section view of an ITC hearing aid situated in a human ear.

FIG. 21 is partial cross-section view of a CIC hearing aid situated in a human ear.

### DETAILED DESCRIPTION

An electrically small loop antenna, as described herein, may enable hearing aids or other communication devices to have short-range wireless transceiver functions, such as reception of digital/analog audio, binaural processing, as well as wireless programming and/or configuration. The antenna described herein is preferably a 900 MHz antenna, although other frequencies are possible. A 900 MHz antenna may enable high sensitivity in a very small space and thus is well suited for installation in the irregular shape of a hearing aid shell, for example.

The electrically small loop antenna may be built on a flexible layer of substrate, commonly known as flex, that can be attached to non-conductive surfaces. The disclosed matching circuit may also be on the flex. In this manner, the electrically small loop antenna may be put on an external surface of the shell of a BTE hearing aid or within the hearing aid shell.

Furthermore, the electrically small loop antenna may be incorporated in any miniature wireless system requiring the reception and transmission of audio or bi-directional data transfer at extremely low power consumption. This includes, but is not limited to, hearing aids, assistive listening devices, wireless headsets, ear-buds, body worn control, sensor, and communication devices. An example of a wireless hearing aid system that may include the electrically small loop antenna described herein is described in the commonly-owned U.S. patent application Ser. No. 10/987,776, filed on Nov. 12, 2004, entitled “Hearing Instrument Having A Wireless Base Unit,” and which is incorporated herein by reference.

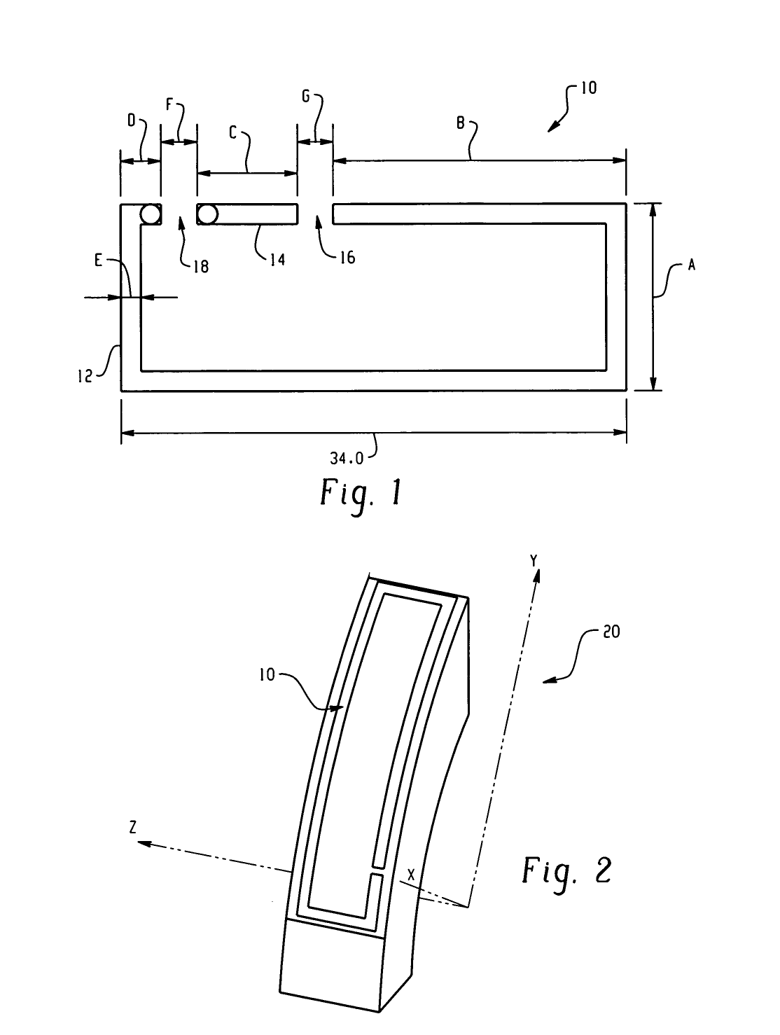

FIG. 1 shows a layout diagram of an example electrically small loop antenna 10. The loop antenna 10 has a first portion 12 and a second portion 14. The first and second antenna portions 10, 12 define two gaps 16, 18. Also illustrated are example dimensions for the antenna portions 12, 14 and the two gaps 16, 18, which are labeled A-G.

Several prototypes of the example loop antenna 10 were constructed, each with different dimensions A-G. The prototype loop antennas were analyzed, including an analysis of the human proximity to the antenna. The measurement results show that the antenna loss over working frequency range was less than 5 dB, the antenna demonstrated a reduced human detuning effect, and the antenna was omni-directional. Table 1 illustrates the dimensions of the prototype antennas and the resulting capacitances.

TABLE 1

| | | | | | | | | C_a | C_b |
|---|---|---|---|---|---|---|---|---|---|
| Build | A | B | C | D | E | F | G | (pF) | (pF) |
| 1 | 8.5 | 24.0 | 3.75 | 4.0 | 0.8 | 2.0 | 0.25 | 0.5 | 0.7 |
| 2 | 8.5 | 24.0 | 3.75 | 4.0 | 1.0 | 2.0 | 0.25 | 0.5 | 0.7 |
| 3 | 8.5 | 24.0 | 3.75 | 4.0 | 1.2 | 2.0 | 0.25 | 0.35 | 0.7 |
| 4 | 8.5 | 12.0 | 3.75 | 16.0 | 1.2 | 2.0 | 0.25 | 0.5 | 0.7 |
| 5 | 14.5 | 24.0 | 3.75 | 4.0 | 1.2 | 2.0 | 0.25 | 0.5 | 0.55 |
| 6 | 14.5 | 12.0 | 3.75 | 16.0 | 1.2 | 2.0 | 0.25 | 0.6 | 0.70 |
| | All sizes in | | | | | | | | |
| | mm | | | | | | | | |

The electrically small loop antenna 10 of FIG. 1 may be attached to non-conductive surfaces, such as Polyethylene, FR-4, Duroid, or others. The loop antenna 10 may, for example, be attached to a thin layer of flex that is attached to the shell of a BTE hearing aid. FIGS. 2, 7, and 8 illustrate examples of electrically small loop antennas on flex attached to the shell of a BTE hearing aid.

The loop antenna's efficiency is related to the area covered by the antenna aperture, as well as the size of the aperture, as shown by Table 1. Therefore, the area of the loop antenna affects the performance of the system, including parameters such as receiver sensitivity and transmission range. Attaching the antenna to the shell of the BTE as shown in FIGS. 2, 7, and 8 utilizes the limited size of the antenna to achieve high sensitivity, low loss and optimal performance for a wireless system. The antenna may be attached to the inner surface of the shell, or it may be attached to the outer surface of the shell to maximize the size of the aperture.

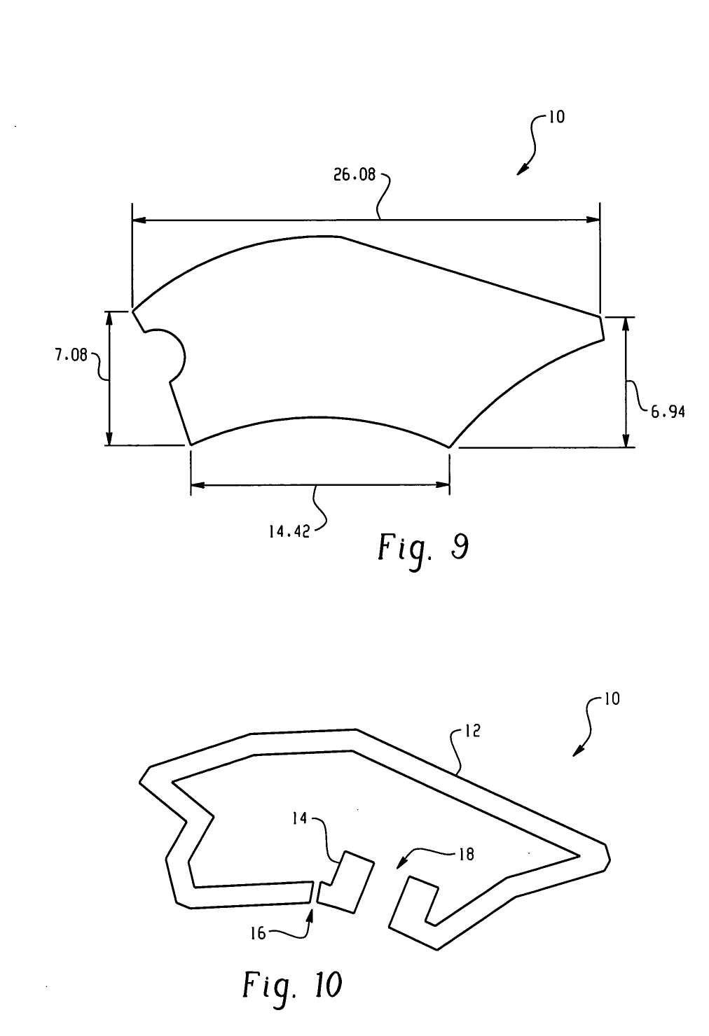

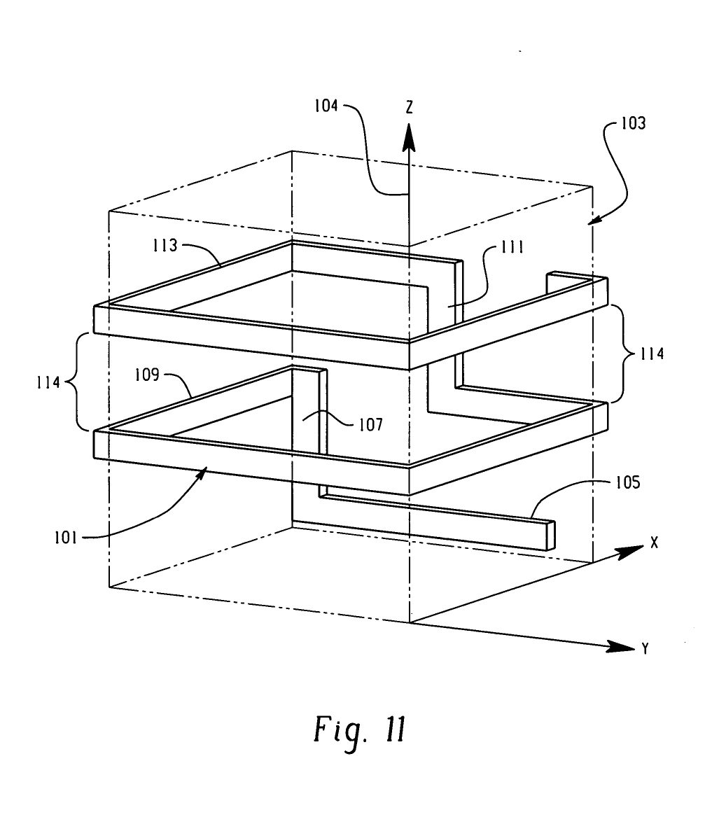

FIGS. 9 and 10 depict an irregular shape that corresponds to the shape of the shell of an example BTE hearing aid. By matching the shape of the loop antenna to the irregular shape of the BTE hearing aid, the aperture of the antenna may be maximized to the space available on the shell of the hearing aid. FIG. 9 shows the shape of an example BTE hearing aid, including example dimensions. FIG. 10 shows an example loop antenna having a shape corresponding to the BTE hearing aid shape of FIG. 9. The size of the antenna may be +100%, −25% extended.

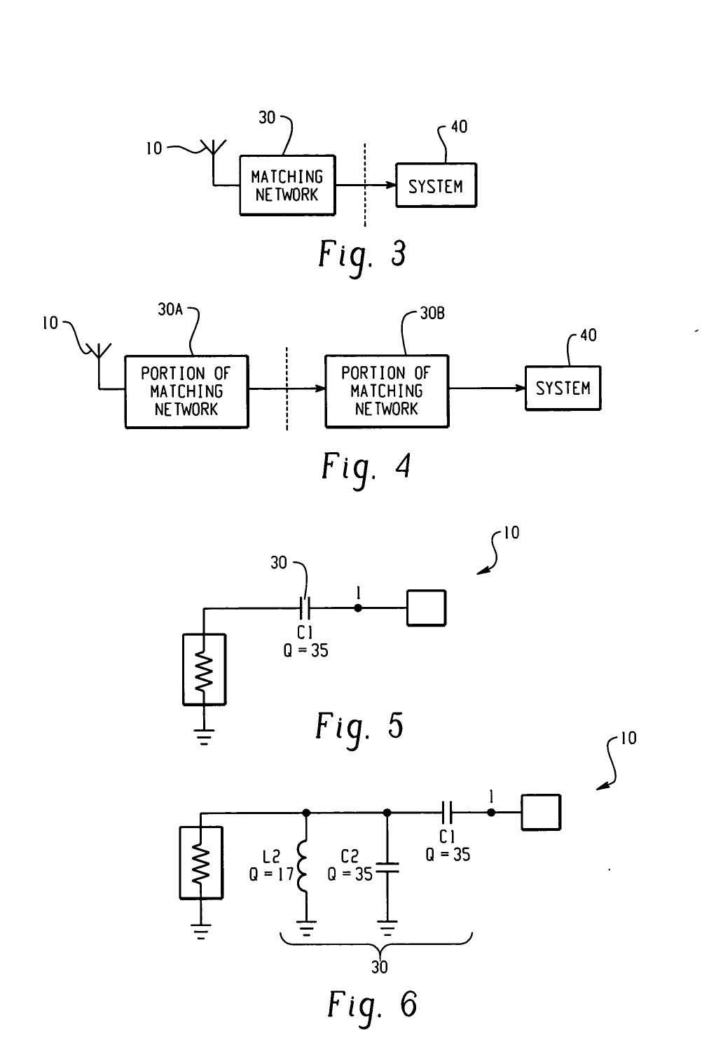

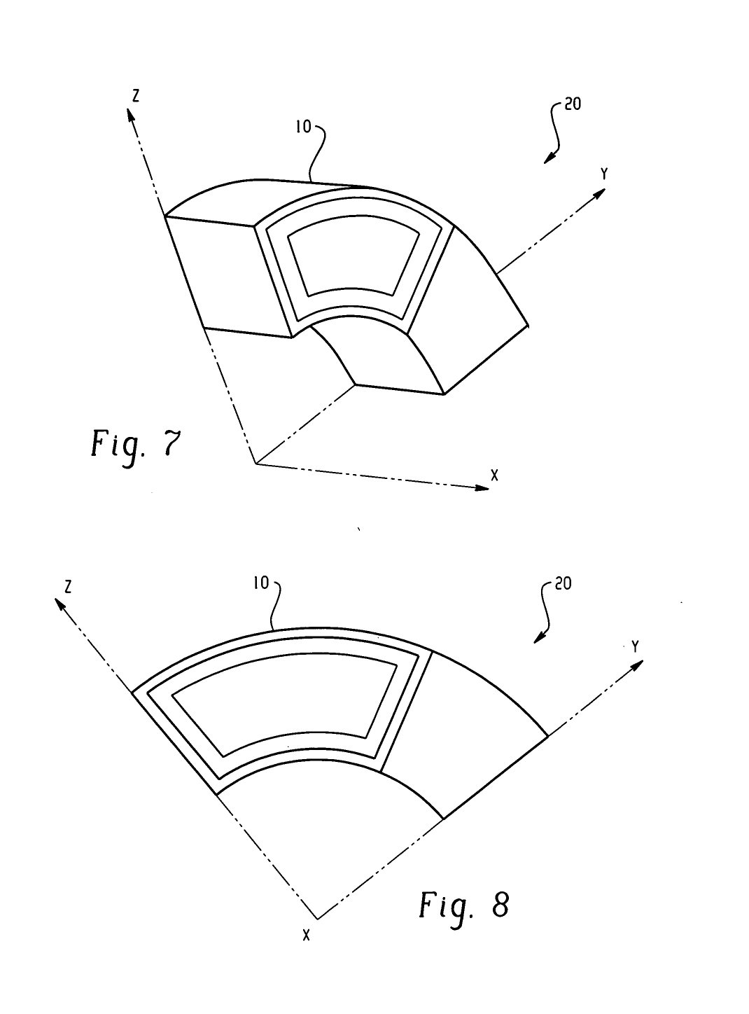

FIGS. 3 and 4 illustrate two example hearing instrument topologies in which one or more matching networks 30, 30A, 30B are coupled between the loop antenna 10 and a hearing aid system 40. Also illustrated in FIGS. 3 and 4 is a dotted line that represents the hearing aid shell. The matching network(s) 30, 30A, 30B function as an interface between the loop antenna 10 and the communication circuitry 40 in the hearing aid, and may increase the efficiency of the antenna 10. The loop antenna 10 may be coupled to the matching network(s) 30, 30A at both antenna feeding points, or alternatively one antenna feeding point may be coupled to a matching network 30, 30A and the other feeding point to ground. In the example of FIG. 3, the matching network 30 is attached to the outer surface of the hearing aid shell, typically on the flex material that carries the antenna as illustrated by the placement of the dotted line. In the example of FIG. 4, a first portion 30A of the matching network is attached to the outer surface of the hearing aid shell and a second portion 30B of the matching network is contained within the hearing aid shell. For example, FIG. 6 shows a matching network 30 comprising capacitors C1, C2 and inductor L2. Of these three passive elements C1, may be placed on the flex material, such as in the gap 16 shown in FIG. 7, whereas elements C2 and L2 may be placed on a circuit board within the hearing aid housing.

There are at least two different matching networks for a 50 ohm system. One is for narrow band conjugate matching, and the other is for medium bandwidth matching. Considering the limitation of the size and space for BTE hearing aid application, the narrow band conjugate method may be preferable.

FIG. 5 shows an example of a narrow band matching network. The matching network includes a capacitor 30 (C1) that is coupled in series between the loop antenna 10 and the hearing aid communications circuitry. The capacitor 30 (C1) on flex (such as in the gap 16 shown in FIG. 1) has a strong tuning effect on the center working frequency. The combination of the radiation resistance, the Q factor of the capacitor 30 (C1) (35 in this example), and the loss from the substrate and conductor determines the antenna bandwidth (e.g., 3 dB). Measurements of the prototype antennas described above demonstrated a center frequency that is adjustable around 900 MHz. The example 3 dB bandwidth is about 16.95%.

FIG. 6 shows an example of a medium band matching network. The matching network includes a first capacitor C1 coupled in series between the loop antenna and the hearing aid communications circuitry, and an LC circuit (C2, L2) coupled in parallel with the loop antenna. The LC circuit includes a second capacitor C2 and an inductor L2. In this example, both capacitors C1, C2 have a Q value of 35, and the inductor has a Q value of 17. Although the example medium band matching circuit shown in FIG. 6 can cover 25%, 3 dB bandwidth, it may not be preferred for hearing aids due to size and space limitations.

FIGS. 11-21 are directed to a multiple-level loop antenna. This antenna has the advantage of fitting into an even smaller housing than the previously disclosed antenna while operating at high frequencies such as 900 MHz. The multiple-level loop antenna can, for example, be fit into CIC and ITC hearing aids, as well as a boot housing that can be coupled with hearing aids and other electronic communication devices. This antenna design allows manufacturers to minimize the size of the hearing aid while providing short-range wireless transceiver functionality at high frequencies.

The example multiple-level loop antenna may also provide additional benefits. For example, it has superior resistance to human detuning effects, and it is easy to assemble when configured on a flexible substrate. The flexible substrate can be assembled into many sizes and shapes of housings. This example multiple-level loop antenna also exhibits medium gain, omni-directionality, and linear polarization.

An example multiple-level antenna 101 with a zig-zag transition is depicted in FIG. 11. The example antenna 101 is disposed on a four-sided piece of flexible substrate 103. The antenna 101 wraps around the flexible substrate in a counter-clockwise direction as it rises on the z-axis 104. A first antenna portion 105 wraps around one side on the first level of the four-sided flexible substrate 103 and is connected by a first substantially vertical transition antenna portion 107 to a second antenna portion 109. The second antenna portion 109 wraps around four sides on the second level of the four-sided flexible substrate 103 and is connected by a second substantially vertical transition antenna portion 111 to a third antenna portion 113. There is an approximately consistent gap 114 that separates each antenna portion from the antenna portion on the level above or below it. A gap of approximately 1.0-2.0 mm reduces inductance in the antenna 101 and enhances performance. The third antenna portion 113 wraps around all four sides and terminates on the side where the third antenna portion 113 and the first antenna portion 105 began. In all, the antenna 101 makes a total of two whole revolutions about the flexible substrate 103. The dimensions of the flexible substrate 103 in this example are approximately 10.0 mm×10.0 mm×7.0 mm (corresponding to the x, y, z axes respectively). The antenna trace itself has a height (z-direction) of approximately 1 mm.

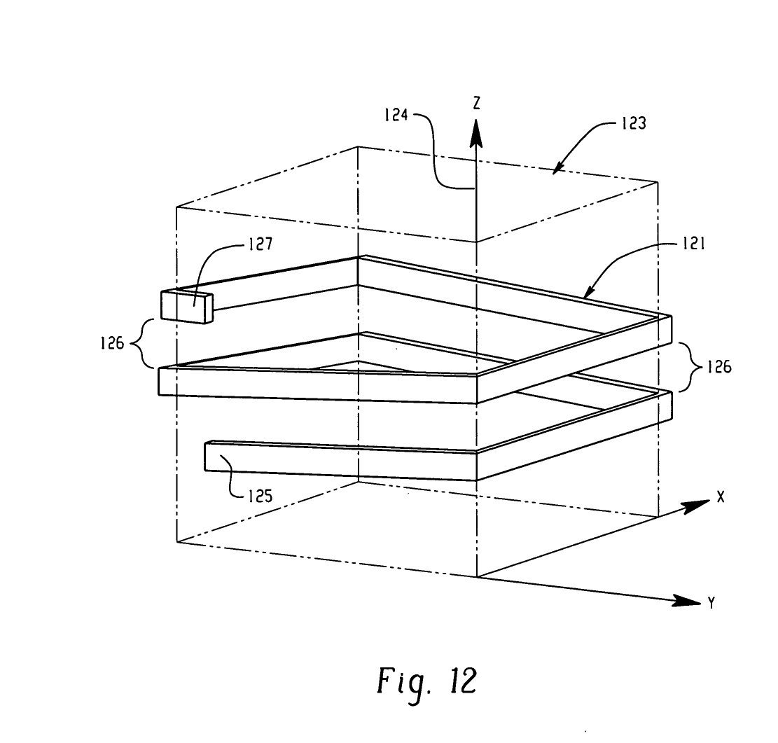

FIG. 12 shows an example of a multi-level loop antenna 121 with a spiral transition. This example antenna 121 is disposed on a four-sided flexible dielectric substrate 123. The example antenna 121 spirals around the sides of the flexible substrate 123 in a counter-clockwise direction as it rises on the z-axis 124 at an approximately constant angle of inclination. The example antenna 121 has two levels. The antenna 121 is determined to have two levels because no part of the antenna 121 has more than one revolution above or below it, and at least part of the antenna has one revolution above or below it. A total of two revolutions are made by the example antenna 121 as it spirals around the flexible substrate 123. There is an approximately consistent gap 126 that separates each antenna revolution from the revolution above or below it. Similar to the above example, a gap of approximately 1.0-2.0 mm reduces inductance in the antenna 121 and enhances performance. The lower terminal end of the antenna 125 and the upper terminal end of the antenna 127 are disposed on the same side of the flexible substrate 123. The dimensions of the flexible substrate 123 in this example are approximately 10.0 mm×10.0 mm×7.0 mm. The antenna trace itself has a height (z-direction) of approximately 1 mm.

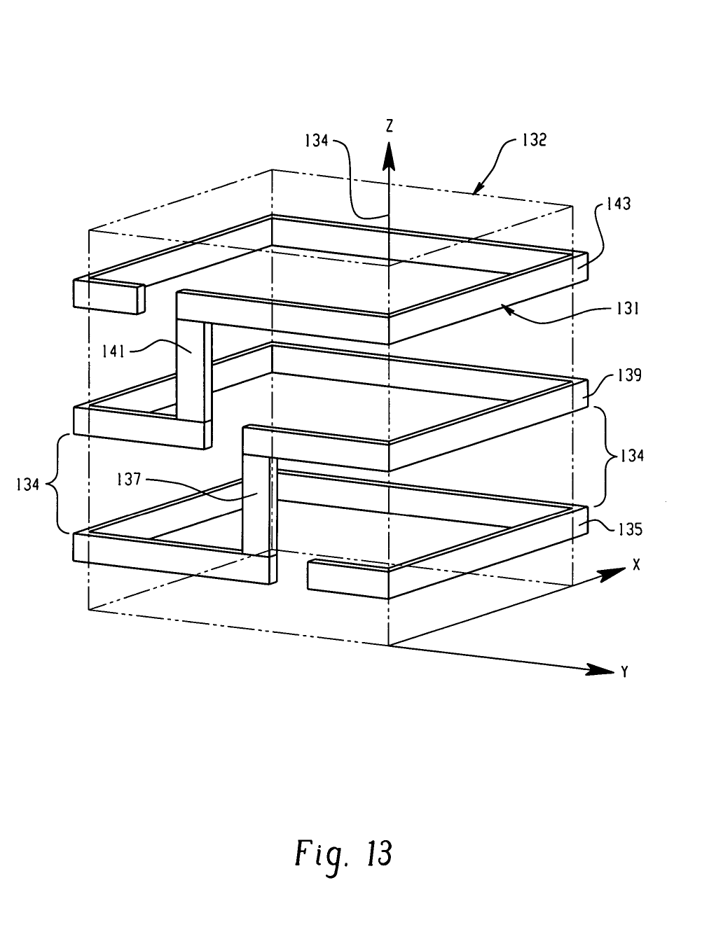

A second example multiple-level antenna 131 with a zig-zag transition is depicted in FIG. 13. The example antenna 131 is disposed on a four-sided piece of flexible substrate 132. The example antenna 131 wraps around the flexible substrate 132 in a counter-clockwise direction as it rises on the z-axis 134. A first antenna portion 135 wraps around all sides on the first level of the four-sided flexible substrate 132 ending on the side it began on and is connected by a first substantially vertical transition antenna portion 137 to a second antenna portion 139. The second antenna portion 139 also wraps around all four sides on the second level of the four-sided flexible substrate 132 ending on the side it began on and is connected by a second substantially vertical transition antenna portion 141 to a third antenna portion 143. The third antenna portion 143 wraps around all four sides and terminates on the side where the third antenna portion 143 and the first antenna portion 135 began.

There is an approximately consistent gap 134 that separates each antenna portion from the antenna portion on the level above or below it. A gap of approximately 1.0-2.0 mm reduces inductance in the antenna 131 and enhances performance. In all, the antenna 131 wraps around the flexible substrate 132 a total of nearly three whole revolutions. The wrapping pattern of this example antenna 131 maximizes the amount of antenna disposed on the given dielectric flexible substrate surface 132 for patterns with zig-zag transitions. The dimensions of the flexible substrate 132 in this example are approximately 7.2 mm×7.2 mm×8.0 mm, of which the antenna wraps around all sides and approximately 7.5 mm of the substrate 132 in the z-axis dimension. The volume encompassed by the antenna in this example is approximately 389 mm³. Other examples with this example wrapping pattern have the following dimensions for the flexible substrate: approximately 10.0 mm×10.0 mm×7.0 mm. The antenna trace itself has a height (z-direction) of approximately 1 mm.

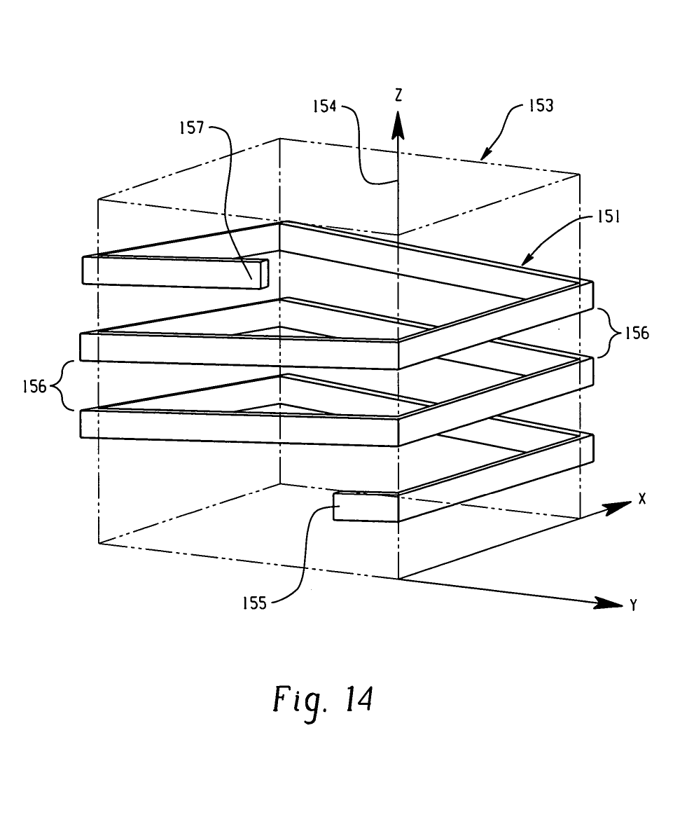

FIG. 14 shows a second example of a multi-level antenna 151 with a spiral transition. This example antenna 151 is disposed on a four-sided flexible dielectric substrate 153. The example spiral antenna 151 wraps around the sides of the flexible substrate 153 in a counter-clockwise direction as it a rises on the z-axis 154 at an approximately constant angle of inclination. The example antenna 151 has three levels, because no part of the antenna 151 has more than two revolutions above or below it, and at least part of the antenna 151 has two revolutions above or below it. There is an approximately consistent gap 156 that separates each antenna revolution from the revolution above or below it. Similar to the above examples, a gap of approximately 1.0-2.0 mm reduces inductance in the antenna 151 and enhances performance. The example antenna 151 makes a total of three revolutions around the flexible substrate 153. The lower terminal end of the antenna 155 and the upper terminal end of the antenna 157 are disposed on the same side of the substrate. The dimensions of the flexible substrate 153 in this example are approximately 8.5 mm×6.25 mm×7.0 mm. The antenna trace itself has a height (z-direction) of approximately 1 mm.

The antennas shown herein are only intended as examples of the many possible configurations of the multi-level antenna. Variations of the above example multi-level antennas include having different shaped flexible substrates for the antenna to wrap around. For example, cylindrical, oval, conical, irregular, or some other shape of dielectric substrate may be utilized with the antenna. The antenna could also be wrapped in patterns that are different from those shown in the Figures. For example, the antenna could have any number of transition portions reaching any number of levels, it could have different numbers of revolutions, different trace heights, or it could have a varying spiral slope, among other differences.

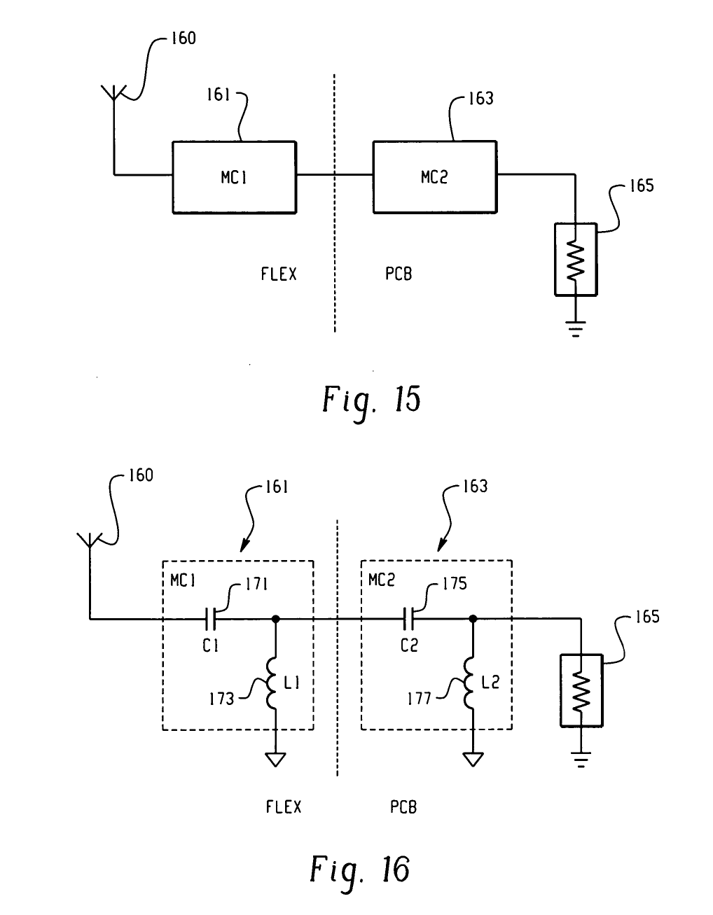

An example matching network topology to be used with the above described multi-level loop antenna is depicted in FIGS. 15-16. FIG. 15 shows a multi-level loop antenna 160 connected to a first matching circuit 161 of an example matching circuit network. The first matching circuit 161 is a conjugating matching circuit and is disposed on a flexible substrate. It is connected to a second matching circuit 163 on a printed circuit board. The second matching circuit 163 is coupled to a load 165 that represents the communication device used with the antenna system.

A more detailed view of the matching circuit is shown in FIG. 16. FIG. 16 shows a first matching circuit 161 that comprises a first capacitor 171 with a Q factor of 35 and a capacitance of 0.1-0.5 Pf coupled to a first inductor 173 having an inductance of 15 nH. The second matching circuit 163 comprises a second capacitor 175 with a Q factor of 35 and a capacitance of 2.8 pF coupled to a second inductor 177. The antenna 160 is coupled to the first matching circuit 161, which is in turn coupled to the second matching circuit 163 and the load 165. AvX Accu-P series capacitors are used in this example matching circuit. The capacitance can vary according to several factors, such as: the number of revolutions of the antenna, the size of the revolution, and the frequency at which the antenna is operating.

FIG. 17 is a see-through view of a boot 201 housing an example multiple-level loop antenna 203. The boot 201 is designed to have a connector 205 plugged into a BTE type of hearing instrument, or possibly into other electronic devices to provide wireless functionality. The antenna 203 and flexible substrate 204 surround a printed circuit board 207, which is situated in the center of the boot 201. The boot 201 includes an on/off switch 209.

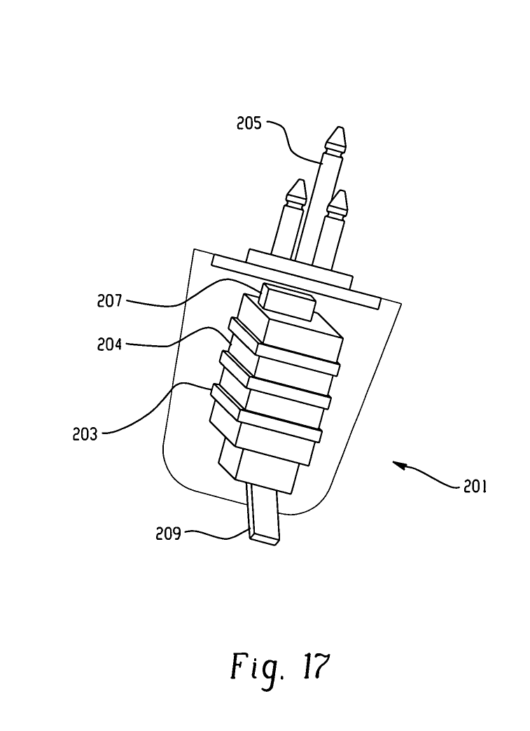

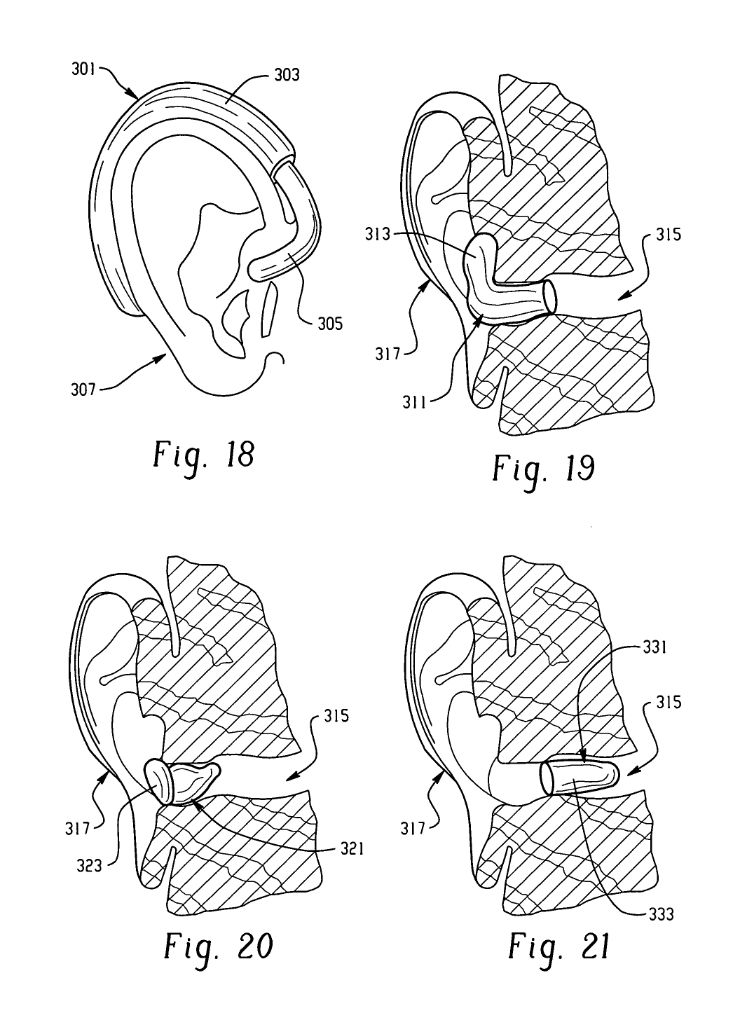

FIG. 18 shows an example BTE hearing aid 301 having a housing 303 and an extended arm 305 situated oh a human ear 307. Typical dimensions for BTE hearing aids are 30-60 mm tall, 25-45 mm wide, and 10-16 mm thick (thickness being the dimension that runs from ear to ear), at their greatest dimensions. An estimated range of volumes of a typical BTE with the above dimensions is 3500-15000 mm³. The multi-level loop antenna (not shown) is located in the housing 303 of the BTE 301 along with a PCB including one or more matching circuits. BTE hearing aids are generally larger and provide more area for the antenna, transceiver and other circuitry. The multi-level loop antenna could provide for a larger broadcast range as it could encircle a greater area in this housing.

FIGS. 19-21 show example ITE, ITC, and CIC hearing aid housings in which the example multi-level loop antenna can be inserted. For each housing the example multi-level loop antenna wraps around at least part of the interior of the housing, preferably on a flexible substrate. A PCB with at least one matching network is at least partly encircled by the antenna. Part or all of the one or more matching networks may also be on the flexible substrate with the antenna.

FIG. 19 shows an example ITE hearing aid 311 having a housing 313 that is partly in the ear canal 315 and partly in the outer ear 317. Typical dimensions for ITE hearing aids are 19-25 mm tall, 16-20 mm wide, and 15-20 mm thick, at their greatest dimensions. A range of approximate volumes for ITE hearing aids is 4560-8000 mm³.

FIG. 20 shows an example ITC hearing aid 321 having a housing 323 that is mostly in the ear canal 315 and partly in the opening of the outer ear 317. Typical dimensions for ITC hearing aids are 15-19 mm tall, 10-14 mm wide, and 12-17 mm thick, at their greatest dimensions. These dimensions yield an approximate range of volumes of 1800-4522 mm³.

FIG. 21 shows an example CIC hearing aid 331 having a housing 333 that is completely in the ear canal 315. Typical dimensions for CIC hearing aids are about 12-14 mm tall, 6-8 mm wide, and 10-15 mm thick, at their greatest dimensions. These dimensions yield an approximate range of volumes of 720-1680 mm³.

The multi-level loop antenna could be utilized with many types of wireless communication devices. For example, the antenna could be used in any miniature wireless system that utilizes the reception and transmission of audio or bi-directional data transfer at extremely low power consumption. This includes, but is not limited to, assistive listening devices, wireless headsets, ear-buds, body-worn controllers, sensors, and communication devices.

The antenna functions to impart short-range wireless capabilities. The example antennas shown in the Figures are designed to have a range of approximately three meters. The device is preferably a body worn, personal device that operates to provide high quality, digital audio to the user.

One application of the multi-level loop antenna is to provide short-range wireless capabilities to devices such as those listed above. Wireless transmissions to the device could be used to program settings in the device. Audio signals could also be transmitted to the device. For example, radio or music could be transmitted to the device and to the user's ear. Also, telephone communications could be transmitted to the hearing device. This would be particularly advantageous in making connections to cellular phones.

The examples disclosed in this application present users with new and greater opportunities for enjoyment and interactivity with their environment by employing the wireless capability in hearing devices. For example, wireless transmissions of live events could be broadcast throughout the event area, and those with wireless hearing aids would be able to hear the event regardless of their proximity to a speaker. For persons that are sight impaired, wireless beacons could be set up in various environments to warn or direct users of the device from dangers or obstacles in the area. Similar applications of the technology are possible in various other situations as well.

Another application of the antenna implemented in a hearing device that is particularly useful for users that have a hearing aid in both ears is that the antenna can provide bidirectional communications between the two hearing aids for the purpose of optimizing hearing performance.

The devices disclosed in this document could also be modified to include a broadcast mode where the size and power of the transmitter is not constrained in a very small housing, and a larger external power amplifier is connected. Typical broadcast ranges for a device with this mode are about ten meters, but could be more.

It is claimed:

1. A wireless hearing aid having a communication system positioned within a housing structure for receiving and processing wireless signals and for presenting those signals to a wearer of the hearing aid, the wireless hearing aid comprising:
a multi-level loop antenna configured to make more than one revolution around a center point and to be on multiple levels, wherein a first part of the antenna is on a first level and one or more parts of the antenna are on one or more levels above the first part;
one or more matching networks coupling the multi-level loop antenna to the communication system;
the multi-level loop antenna being contained within or coupled to the housing structure; and
the antenna being operable to receive signals at a frequency range of 716 to 928 MHz.

2. The wireless hearing aid of claim 1, wherein the housing structure is positioned in close proximity to the human body of the wearer.

3. The wireless hearing aid of claim 1, wherein the antenna is disposed on a flexible dielectric substrate.

4. The wireless hearing aid of claim 1, wherein the housing is one of an in the canal hearing aid (ITC), completely in the canal hearing aid (CIC), or a boot attachable to a hearing aid.

5. The wireless hearing aid of claim 1, wherein the multi-level loop antenna is operable at about 900 MHz.

6. The wireless hearing aid of claim 1, wherein the multi-level loop antenna makes more than two whole revolutions and is on three levels.

7. The wireless hearing aid of claim 3, wherein part of the matching circuit is assembled on the flexible dielectric substrate.

8. The wireless hearing aid of claim 3, wherein the flexible dielectric substrate is affixed to one of an outer or an inner surface of the housing structure.

9. The wireless hearing aid of claim 1, wherein the multi-level loop antenna is positioned along a periphery of a portion of the housing structure so as to maximize the aperture of the multiple-level loop antenna.

10. The wireless hearing aid of claim 1, wherein the received wireless signals are used, in part, to configure the operation of the wireless hearing aid.

11. The wireless hearing aid of claim 1, wherein the communication system includes a receiver and a transmitter, the multi-level loop antenna being utilized for both receiving wireless signals and transmitting wireless signals.

12. The wireless hearing aid of claim 1, wherein the levels of the antenna are separated by approximately 1.0 mm.

13. A wireless hearing aid having a communication system positioned within a housing structure for receiving and processing wireless signals and for presenting those signals to a wearer of the hearing aid, the wireless hearing aid comprising:
a multi-level loop antenna that is configured to make more than one revolution around a center point and to be on multiple levels, wherein a first part of the antenna is on a first level and one or more parts of the antenna are on one or more levels above the first part;
one or more matching networks coupling the multi-level loop antenna to the communication system;
the multi-level loop antenna being contained within or coupled to the housing structure; and
wherein the antenna and at least part of the one or more matching networks is disposed on a flexible dielectric substrate;
the housing structure having a volume of less than about 5000 mm³.

14. The wireless hearing aid of claim 13, wherein the antenna is operable to receive at a frequency range of 716-928 MHz.

15. The wireless hearing aid of claim 13, wherein the housing is one of an in the canal hearing aid (ITC), completely in the canal hearing aid (CIC), or a boot attachable to a hearing aid.

16. The wireless hearing aid of claim 13, wherein the multi-level loop antenna is operable at about 900 MHz.

17. The wireless hearing aid of claim 13, wherein the multi-level loop antenna has three levels.

18. The wireless hearing aid of claim 13, wherein the flexible dielectric substrate is affixed to one of an outer or an inner surface of the housing structure.

19. The wireless hearing aid of claim 13, wherein the multi-level loop antenna is positioned along a periphery of a portion of the housing structure so as to maximize the aperture of the multiple-level loop antenna.

20. The wireless hearing aid of claim 13, wherein the received wireless signals are used, in part, to configure the operation of the wireless hearing aid.

21. The wireless hearing aid of claim 13, wherein the communication system includes a receiver and a transmitter, the multi-level loop antenna being utilized for both receiving wireless signals and transmitting wireless signals.

22. The wireless hearing aid of claim 1, wherein the levels of the antenna are separated by at least approximately 1.0 mm.

23. A wireless hearing aid having a communication system positioned within a housing structure for receiving and processing wireless signals and for presenting those signals to a wearer of the hearing aid, the wireless hearing aid comprising:
a multi-level loop antenna that is configured to make more than one revolution around a center point and to be on multiple levels, wherein a first part of the antenna is on a first level and one or more parts of the antenna are on one or more levels above the first part, and the levels are separated by at least approximately 1.0 mm; and
one or more matching networks coupling the multi-level loop antenna to the communication system;
the multi-level loop antenna being contained within or coupled to the housing structure;
wherein the housing is one of an in the canal hearing aid (ITC), completely in the canal hearing aid (CIC), or a boot attachable to a hearing aid.

24. The wireless hearing aid of claim 23, wherein the antenna is operable to receive at a frequency range of 716-928 MHz.

25. The wireless hearing aid of claim 24, wherein the multi-level loop antenna is operable at about 900 MHz.

26. The wireless hearing aid of claim 23, wherein the communication system includes a receiver and a transmitter, the multi-level loop antenna being utilized for both receiving wireless signals and transmitting wireless signals.

27. A wireless electronic device having a communication system positioned within a housing structure for receiving and processing wireless signals, comprising:
a multi-level loop antenna that is configured to make more than one revolution around a center point and to be on multiple levels, wherein a first part of the antenna is on a first level and one or more parts of the antenna are on one or more levels above the first part;
one or more matching networks coupling the multi-level loop antenna to the communication system;
the multi-level loop antenna being contained within or coupled to the housing structure; and
the antenna being operable to receive signals at a frequency range of 716-928 MHz;
wherein the antenna encompasses a volume of less than approximately 2000 mm³.

28. The wireless electronic device of claim 27, wherein no dimension of the housing is greater than approximately 20 mm.

29. The wireless electronic device of claim 27 wherein the housing has a total volume of less than approximately 2000 mm³.

30. The wireless electronic device of claim 27, wherein the antenna encompasses a volume of approximately 389 mm3.
